(19) United States
(12) Patent Application Publication
(10) Pub. No.: US 2006/0201747 A1
(43) Pub. Date: Sep. 14, 2006

(54) Ladder for working concrete

(76) Inventor: Rodger Walton, Warsaw, IN (US)

Correspondence Address: Lawrence J. Shurupoff, 16651 Topanga Lane, Delray Beach, FL, 33484, US

(21) Appl. No.: 11/077,766

(22) Filed: Mar. 11, 2005

(51) Int. Cl. E06C 1/36

(52) U.S. Cl. 182/206

(57) ABSTRACT

A ladder is provided with a pair of vertically adjustable hangers for suspending the ladder from a wall or other structure. A working platform is pivotally connected to the bottom of the ladder to support and suspend a worker over a freshly poured concrete floor in such a manner that the worker may work the concrete beneath the platform without stepping on the freshly poured concrete floor.

### BACKGROUND OF THE INVENTION

1. Field of the Invention

The present invention relates in general to work ladders, and in particular to a ladder having a working platform for supporting a worker over a freshly poured concrete floor.

2. Description of Prior Developments

In new building construction a worker typically works a freshly poured concrete basement floor by raking, screeding, vibrating and otherwise leveling and smoothing the floor with various powered and manual tools. A problem arises when the worker nears completion of working the floor, as the worker must somehow complete the basement floor smoothing operation without stepping on the concrete which has just been worked.

One solution has been to suspend a common work ladder from a board extending across and above a corner between two basement walls. A worker then climbs up on a lower rung of the ladder, and finishes working the area beneath the ladder. Once done, the worker climbs up the ladder to ground level leaving a completely worked floor behind.

It can be appreciated that this prior technique can be awkward for a worker and even potentially dangerous as the worker hangs on the ladder with one hand and works the concrete floor with the other hand. Moreover, because the height of basement walls can vary, a worker may need several ladders of different lengths to match the height of the wall adjacent the floor being worked.

### SUMMARY OF THE INVENTION

The present invention has been developed to overcome the drawbacks noted above and therefore has as an object the provision of a ladder that may be safely and securely mounted and suspended over and adjacent to a freshly poured concrete floor. A height adjustment may be provided to adjust the height of the ladder above the floor so as to allow a worker to easily work the area around and beneath the ladder.

A working platform is provided on the bottom of the ladder to support a worker above the floor with a clearance sufficient to allow the worker to easily access and work the floor around and beneath the platform. The platform may be pivoted to the bottom of the ladder to provide a compact assembly for transport or storage.

The forementioned objects, features and advantages of the invention will, in part, be pointed out with particularity, and will, in part, become obvious from the following more detailed description of the invention, taken in conjunction with the accompanying drawings, which form an integral part thereof.

### BRIEF DESCRIPTION OF THE DRAWINGS

In the drawings;

FIG. 1 is a top perspective view of a construction ladder used in accordance with the prior art;

FIG. 2 is a top perspective view of a ladder constructed in accordance with the present invention;

FIG. 3 is a partial upper left side elevation view of the ladder of FIG. 2;

FIG. 4 is a sectional view through section lines 4-4 of FIG. 2;

FIG. 5 is a partial lower left side elevation view of the ladder of FIG. 2;

FIG. 6 is a sectional view through section line 6-6 of FIG. 2; and

FIG. 7 is a view similar to FIG. 5, showing the platform assembly disposed in a storage or compact transportable position.

In the various Figures of the drawings, like reference numerals designate like or similar parts.

### DETAILED DESCRIPTION OF THE PREFERRED EMBODIMENTS

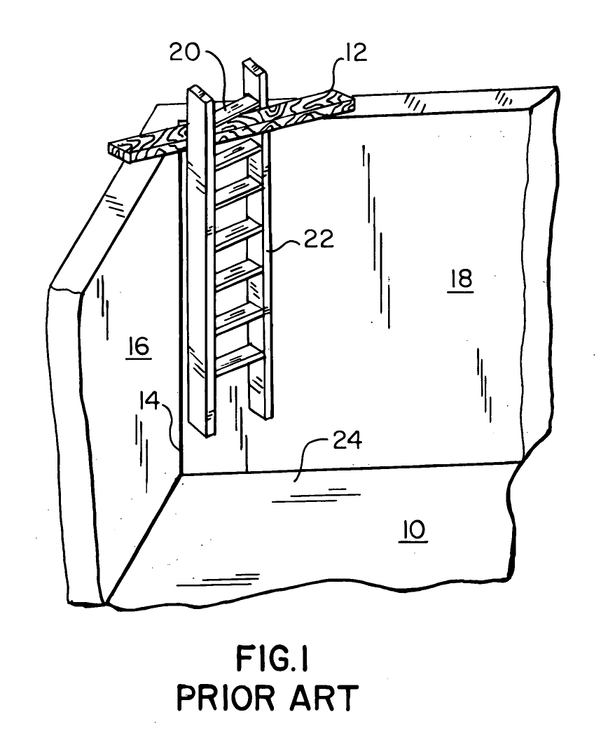

A brief review of a conventional concrete floor working ladder arrangement will be helpful in appreciating the benefits of the present invention. As seen in FIG. 1, a worker, completing the finishing of a newly poured concrete basement floor 10, has placed a board 12 across a corner 14 formed between two basement walls 16 and 18. The board 12 is inserted beneath one of the upper rungs 20 on a common work ladder 22.

When the worker has finished working the entire floor, except for the area 24 beneath the ladder 22, the worker climbs up on the lower rung and finishes working the area 24 while being suspended on the ladder 22. As noted above, this is awkward and potentially dangerous.

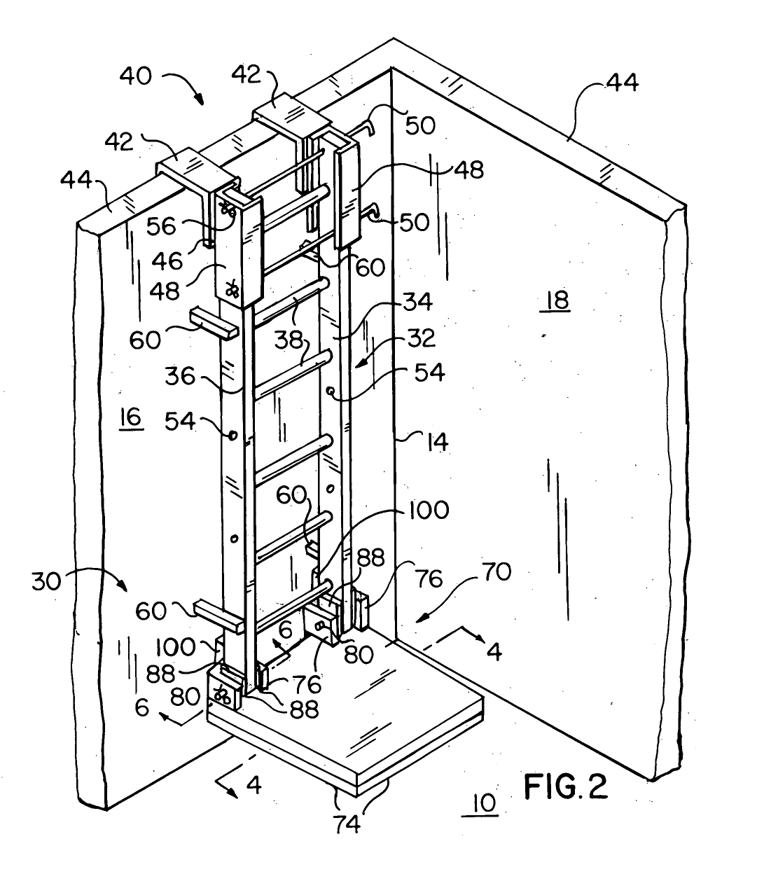

As seen in FIG. 2 the present invention avoids the drawbacks of the ladder of FIG. 1 by providing a rigid, secure ladder assembly 30 for working a newly poured concrete floor 10. Ladder assembly 30 includes a ladder 32 having a pair of side rails 34 and 36. A plurality of vertically spaced rungs 38 is secured to the side rails 34 and 36 in a known fashion. While the side rails 34 and 36 and rungs 38 are preferably formed of aluminum, any suitable material such as wood or composite materials may be used.

The ladder assembly 30 includes a hanger assembly 40 mounted to the top portions of the side rails 34 and 36. Hanger assembly 40 includes a pair of inverted U-shaped hanger hooks 42 adapted to hook over and around the top edges 44 of concrete basement walls 16 and 18. Hooks 42 may be formed of aluminum or steel or any other strong material.

The front face 46 of each hanger hook 42 is connected to a channel-shaped sleeve 48 such as by welding, bolts, or any other suitable fastening technique. Each sleeve 48 includes a pair of arms or side walls extending from a central base so as to embraces three outer sides of each side rail with a close sliding fit. The sleeves 48 are adjustably fastened and pinned to their respective side rails 34 and 36 with removable rods 50.

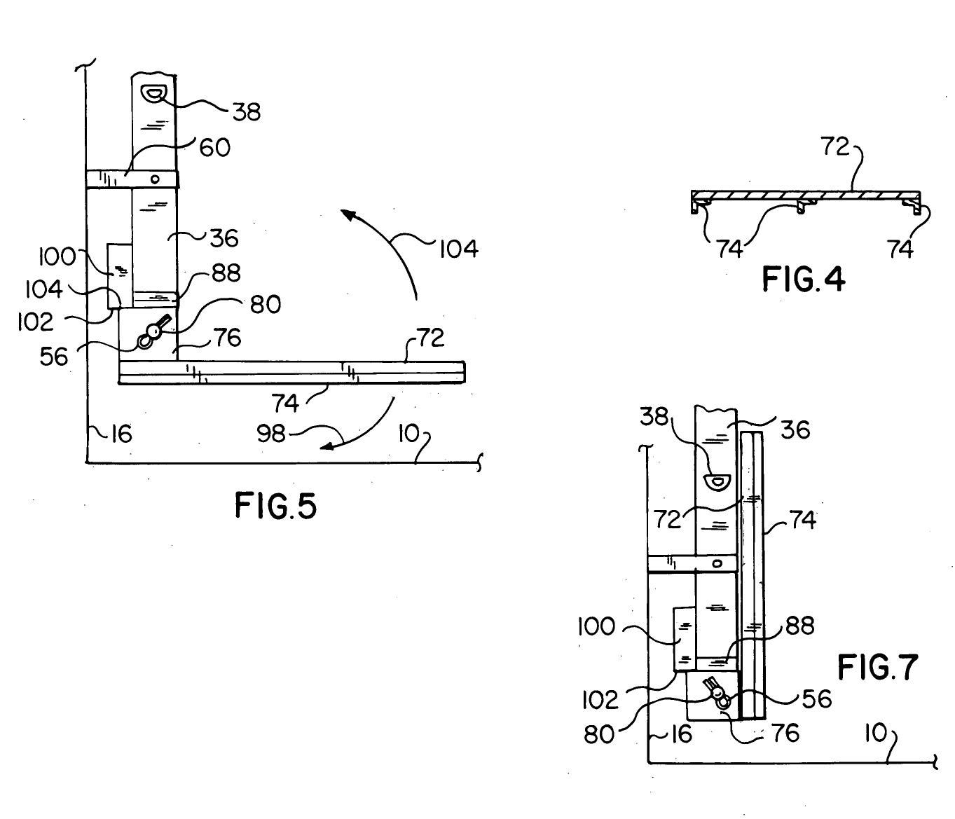

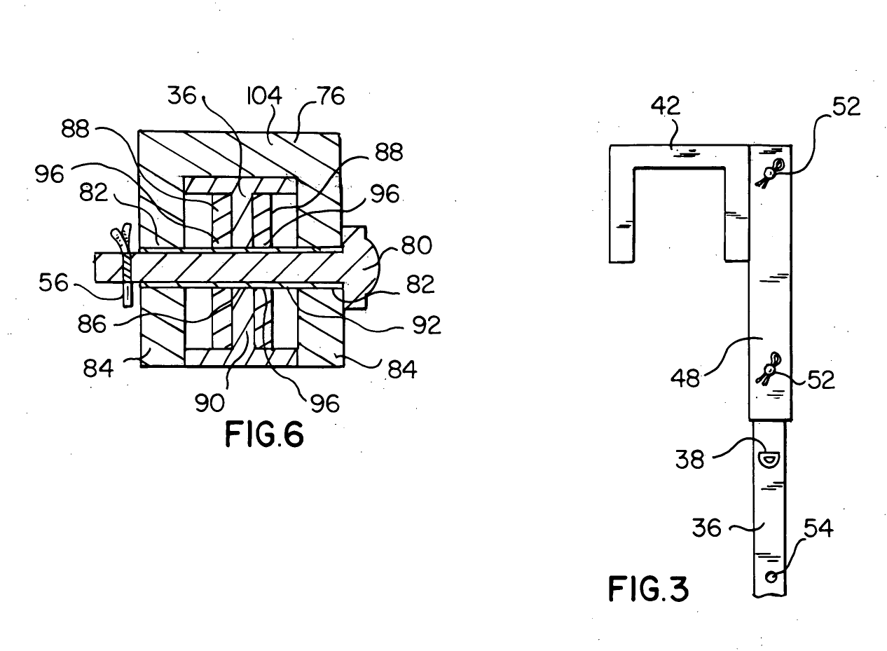

Each rod 50 is insertable through clearance holes 52 (FIG. 3) formed through the base of each sleeve 48. The holes 52 are aligned with matching holes 54 (FIG. 3) formed through each side rail 34 and 36 to allow the rods 50 to pass through the sleeves and side rails. A cotter pin 56 or other fastener may be used to anchor the rods 50 to the sleeves and sidewalls.

The hanger assembly 40 can be adjusted up or down along the side rails by removing the rods 50 and realigning the holes 52 in the sleeve with a desired pair of holes 54 in the side rails. The rods 50 are then reinserted and fastened in place with cotter pins 56. In this manner, the bottom portion of the ladder assembly, including the side rails and lower rungs may be adjusted and suspended at a desired selected distance above the floor 10 so as to allow a worker to freely work the area under the ladder.

In order to provide room between the rear face of the side rails and the wall 16, a pair of rearwardly projecting spacer bars or stand-offs 60 is fixed at vertically spaced distances along each side rail. The spacing from wall 16 provides room for a worker to securely grasp the front, side and rear surfaces of each side rail when climbing up and down on the ladder assembly 30 and to allow a worker to step safely and fully on each rung 38. The spacer bars may be formed of aluminum and bolted, welding or otherwise attached to the side rails 34 and 36.

A support platform assembly 70 is carried on the bottom portion of the ladder assembly 30. Platform assembly 70 includes a planar worker platform 72 extending substantially perpendicularly outwardly from the side rails 34 and 36. The worker platform 72 is preferably about 17 inches wide and projects outwardly about 18 inches from the side rails to allow a worker to freely stand on the worker platform without the need to grasp the side rails.

The worker platform 72 may be formed of a sheet of aluminum, steel or even plywood. The platform 72 may be reinforced with angle bars 74 secured under its entire outer periphery as well as on its central underside as shown in FIG. 4. The platform 72 is secured to the bottom of each side rail with a U-shaped yoke 76. Each yoke 76 extends around the sides and rear face of each side rail 34 and 36, as seen in FIG. 2.

The yokes 76 may be formed of aluminum and welded to the upper rear surface of platform 72. Each yoke is pivotally connected to the bottom portion of each respective side rail 34 and 36 by a pivot pin 80. As seen in FIG. 6, each pivot pin 80 extends through aligned channels 82 formed in each leg 84 of each yoke 76. A similar channel 86 is formed through each side rail and coaxially aligned with channels 82.

In FIG. 6, the side rail 36 is shown having an I-shaped cross section, as is common on aluminum side rails. A pair of metal support plates 88 is welded or otherwise secured to opposite sides of the central web 90 of each side rail 34 and 36 to provide added strength and weight bearing capacity to the pivoted or pinned connection between the side rails and platform assembly 70.

A tubular brass bushing 92 may be press fit through aligned channels 82 and 86 in the yoke and side rails, as well as channels 96 formed through the support plates 88. Bushing 92 adds strength and support to the pinned connection, and reduces wear between moving surfaces.

In order to limit the downward rotation of the platform assembly 70 around the ends of the side rails as indicated by arrow 98 in FIG. 5, a stop block 100, in the form of, for example, an aluminum block is welded or otherwise securely fixed adjacent to the bottom rear face of each side rail. As seen in FIG. 5, the bottom face 102 of stop block 100 is fixed at a position on side rail 36 so as to abut the upper surface of the central base 104 of yoke 76 and so as to securely hold the worker platform 72 at a position extending substantially perpendicularly to the side rails.

Rotation of the worker platform 72 in the opposite or upward direction, as represented by arrow 104 in FIG. 5, is substantially unrestricted until the worker platform rests on or adjacent to the side rails, as shown in FIG. 7. In this position, the worker platform 72 is aligned substantially parallel to the side rails so as to form a compact assembly suitable for easy transport and storage.

In use, a worker aligns the hanger assembly 40 over a wall and extends or pivots the support platform assembly 70 outwardly as shown in FIG. 2. The worker then works or finishes the surface of the floor 10 until all of the floor 10 is worked, except for the area under the platform assembly 70.

The platform assembly 70 is typically suspended or cantilevered over the floor 10 by several inches up to a foot or more through vertical adjustment of the sleeves 48 which carry the hanger hooks 42. This spacing allows a worker to step on worker platform 72 and finish working the area beneath and around the platform assembly 70, i.e. within reach by hand or tool. Once a worker climbs or steps up on the worker platform 72, the worker can work the area around the platform assembly with both hands, as the worker platform is dimensional to provide adequate area for the worker to stand and move about on the worker platform without the need for grasping the side rails.

There has been disclosed heretofore the best embodiment of the invention presently contemplated. However, it is to be understood that the various changes and modifications may be made thereto without departing from the spirit of the invention. For example, while the side rail have been shown as one piece rigid members, the side rails may be provided as collapsible multi-piece members that fold up in an accordion style for space saving, as is known in the industry.

What is claimed is:

1. A ladder, comprising:
a first side rail having a top portion and a bottom portion;
a second side rail having a top portion and a bottom portion;
a plurality of rungs extending between said first and second side rails;
a hanger assembly disposed adjacent said top portions of said first and second side rails;
and
a support platform adapted to project outwardly adjacent said bottom portions of said side rails.

2. The ladder of claim 1, further comprising a first stand-off projecting rearwardly from said first side rail and a second stand-off projecting rearwardly from said second side rail.

3. The ladder of claim 1, further comprising a first sleeve mounted to said top portion of said first side rail and a second sleeve mounted to said top portion of said second side rail.

4. The ladder of claim 3, wherein said hanger assembly is mounted on said first and second sleeves.

5. The ladder of claim 4, wherein said first and second sleeves are adjustable in position along said side rails.

6. The ladder of claim 1, wherein said platform is movable with respect to said side rails.

7. The ladder of claim 6, wherein said platform is pivotally mounted to said side rails.

8. A ladder, comprising:
a pair of side rails interconnected by a plurality of rungs;
a hanger provided on a first end portion of said ladder and adapted to suspend said ladder from a wall; and;
a work platform provided on a second end portion of said ladder and adapted to support a worker above a work surface.

9. The ladder of claim 8, wherein said hanger comprises a pair of hooks.

10. The ladder of claim 8, wherein said hanger extends rearwardly from said side rails and said work platform extends forwardly from said side rails.

11. The ladder of claim 8, wherein said work platform is movable from a position aligned substantially perpendicular to said side rails to a position aligned substantially parallel to said side rails.

12. The ladder of claim 8, wherein said hanger is vertically adjustable along said ladder.

13. The ladder of claim 8, wherein said hanger is pinned to at least one of said side rails.

14. The ladder of claim 8, wherein said work platform is pinned to at least one of said side rails.

15. The ladder of claim 8, further comprising a yoke interconnecting said platform to one of said side rails.

16. The ladder of claim 8, further comprising a stop block fixed to one of said side rails for limiting movement of said platform.

17. The ladder of claim 8, further comprising first and second pairs of stand-offs projecting from said side rails.

18. A method of working a poured concrete floor by a worker using a ladder having a hanger and a worker platform, wherein said method comprises:
suspending the ladder by the hanger from a structure adjacent the poured concrete floor;
and
suspending the worker on the worker platform on the ladder above the poured concrete floor at a height sufficient to allow working of the concrete floor beneath the platform.

19. The method of claim 18, which further comprises working the poured concrete floor while the worker is suspended on the worker platform above the poured concrete floor.

20. The method of claim 18, which further comprises adjusting the height of the worker platform above the poured concrete floor by adjusting the position of the hanger on the ladder
